(19) United States
(12) Patent Application Publication
(10) Pub. No.: US 2007/0211041 A1
(43) Pub. Date: Sep. 13, 2007

(54) Electronic device for moving the display position of a screen by a displacement sensor and method thereof

(75) Inventors: Cheng-Shing Lai, Taipei (TW); Xiao-Long Fan, Nanking (CN); Hao Chen, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/709,850

(22) Filed: Feb. 23, 2007

(30) Foreign Application Priority Data
Mar. 10, 2006 (TW) 095108101

(51) Int. Cl. G06F 3/041

(52) U.S. Cl. 345/173

(57) ABSTRACT

The present invention discloses an electronic device for moving the display position of a screen and a method thereof, which comprises a display device for outputting the screen; a displacement sensor for detecting a displacement of said electronic device to generate a displacement signal; and a processor connected separately to said display device and said displacement sensor, capable of issuing a move instruction according to said displacement signal for moving the display position of said screen.

### FIELD OF THE INVENTION

The present invention relates to an electronic device, more particularly to an electronic device capable of moving the display position of a screen thereof according to a displacement of the electronic device detected by a displacement sensor of the electronic device.

### BACKGROUND OF THE INVENTION

In recent years, semiconductor technology and network communication technology advance rapidly, and thus various portable electronic products such as personal digital assistants (PDAs) and mobile phones tend to be developed with a light, thin, short and compact design to meet market requirements, and their functions and applications can satisfy consumer's needs by integrating a portable electronic product with another electronic consumer product to produce an all-in-one electronic communication product such as a mobile phone being integrated with a personal digital assistant to produce a mobile phone with the functions of a personal digital assistant. The mobile phone not just provides the general voice communication functions, but also connects to a server of Internet directly through a modem transmission circuit and network communication software for uploading, downloading or transmitting information over the network, so as to constitute a mobile phone with a network communication function.

Some designers and manufacturers of portable electronic products have developed a wireless application protocol (WAP) to facilitate users to browse over the Internet from mobile phones, and thus users can browse online news, stock market information and the most updated information anytime and anywhere. Such wireless communication protocol has become an industrial standard for many portable electronic products, and some of the portable electronic products can even be used for browsing a webpage provided by the Internet directly.

However, the resolution of a webpage provided by the Internet is based on the best resolution displayable by a computer display device. At present, the resolution of most computer display devices falls within a range from 640×480 pixels to 1280×1024 pixels, and the resolution of these products falls within a range from 176×220 pixels to 240×320 pixels. From the comparison of the resolution of the display device with the resolution of these products, we can observe that these products are unable to show the entire content of the webpage. In other words, the aforementioned products can show a portion of the webpage only. To allow users to view other portions of the webpage from the aforementioned products, users need to adjust a horizontal scroll bar and a vertical scroll bar constantly by a press key or a touch screen to view the desired browsing position of the whole webpage, and thus such application causes tremendous inconvenience to users. Therefore, finding a simple and easy way for users to adjust the desired browsing position of a webpage through the aforementioned products under existing architecture and high-resolution webpage demands immediate attentions and feasible solutions.

### SUMMARY OF THE INVENTION

In view of the foregoing shortcomings of the prior art, the inventor of the present invention based on years of experience to conduct extensive researches and experiments, and finally invented an electronic device for moving the display position of a screen by a displacement sensor and a method in accordance with the present invention. Therefore, it is an aspect of the present invention to provide an electronic device for moving the display position of a screen by a displacement sensor, and a display device of the electronic device can output a screen, and a displacement sensor of the electronic device can detect a displacement of the electronic device to generate a displacement signal, so that a processor of the electronic device can issue a move instruction according to the displacement signal, and move the display position of the screen according to the move instruction.

Another aspect of the present invention is to provide a method for moving the display position of a screen by a displacement sensor, wherein a displacement sensor of an electronic device detects a displacement of the electronic device to generate a displacement signal; the electronic device issues a move instruction according to the displacement signal; and the electronic device moves the display position of a screen outputted by a display device of the electronic device according to the move instruction.

To make it easier for our examiner to understand the objective, technical characteristics and effects of the present invention, a preferred embodiment will be described with accompanying drawings as follows:

### BRIEF DESCRIPTION OF THE DRAWINGS

FIG. 1 is a schematic view of a structure according to one embodiment of the present invention;

FIG. 2 is a schematic view of a webpage screen according to another embodiment of the present invention;

FIG. 3 is a flow chart according to another embodiment of the present invention;

FIG. 4 is a flow chart of moving the display position of a screen of a display device by a network connecting unit and a storage unit in accordance with another embodiment of the present invention;

FIG. 5 is a flow chart of using a setup interface screen to set and record a move instruction corresponding to a displacement signal in accordance with another embodiment of the present invention;

FIG. 6 is a schematic view of a setup interface screen according to another embodiment of the present invention; and

FIG. 7 is a flow chart of operating a switch according to another embodiment of the present invention.

### DETAILED DESCRIPTION OF THE PREFERRED EMBODIMENTS

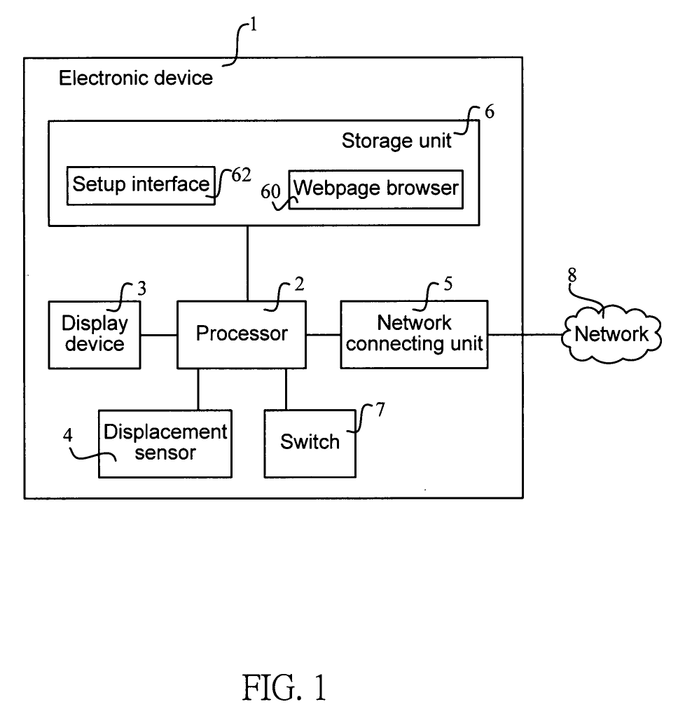

Referring to FIG. 1 for an electronic device for moving the display position of a screen by a displacement sensor in accordance with a preferred embodiment of the present invention, the electronic device 1 comprises a processor 2, a display device 3 and a displacement sensor 4, wherein the processor 2 capable of controlling the electronic device 1, and the display device 3 outputs a screen according to a control signal transmitted from the processor 2, and the displacement sensor 4 detects a displacement of the electronic device 1 to generate a displacement signal, and the processor 2 issues a move instruction according to the displacement signal, and moves the display position of the screen according to the move instruction.

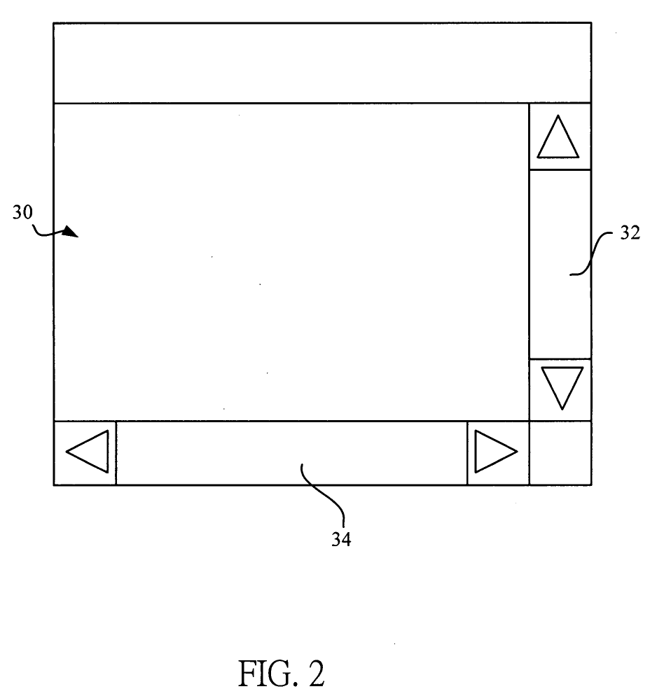

Referring to FIGS. 1 and 2 for another preferred embodiment of the present invention, the electronic device 1 further comprises a network connecting unit 5 and a storage unit 6, wherein the network connecting unit 5 sends different messages of the electronic device 1 to a network 8 and receives a webpage information from the network 8; the storage unit 6 includes a webpage browser 60, such that after the processor 2 of the electronic device 1 starts the webpage browser 60, the network connecting unit 5 receives the webpage information, and the webpage browser 60 outputs a webpage screen 30 on the display device 3 according to the webpage information. When the resolution of the webpage screen 30 is greater than the resolution of the display device 3, the webpage browser 60 will show a vertical scroll bar 32 and/or a horizontal scroll bar 34 on the webpage screen 30. If the displacement sensor 4 detects a displacement of the electronic device 1, then the displacement sensor 4 will generate a displacement signal, and the processor 2 will issue a move instruction according to the displacement signal, and the move instruction will move the vertical scroll bar 32 and/or the horizontal scroll bar 34 for changing the display position of the webpage screen 30.

Referring to FIG. 1 again for a further preferred embodiment of the present invention, the storage unit 6 further comprises a setup interface 62 for setting and recording a move instruction corresponding to the displacement signal, and the move instruction corresponding to the displacement signal is changed to alter the method of moving the display position of the webpage screen 30.

Referring to FIG. 1 again for another further preferred embodiment of the present invention, the electronic device 1 further comprises a switch 7 disposed on a surface of the electronic device 1 for turning on or off a processor 2, and determining whether or not the processor 2 to issue a move instruction according to the displacement signal. In other words, after the switch 7 is turned on, the processor 2 will issue a move instruction according to the displacement signal; and after the switch 7 is turned off, the processor 2 will not issue a move instruction according to the displacement signal.

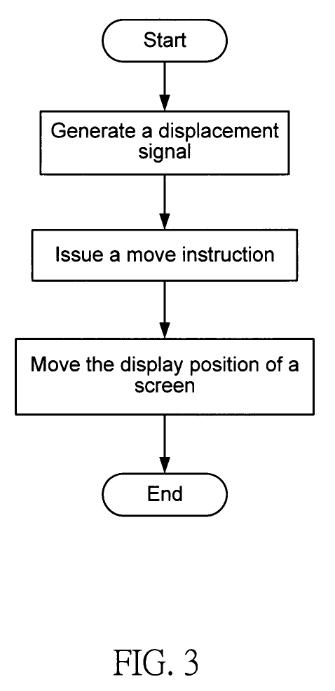

Referring to FIGS. 1 and 3 for a method for moving the display position of a screen by a displacement sensor in accordance with a preferred embodiment of the present invention, a displacement sensor 4 of an electronic device 1 detects a displacement of the electronic device 1 to generate a displacement signal; the electronic device 1 issues a move instruction according to the displacement signal; and the electronic device 1 moves the display position of a screen outputted by a display device 3 according to the move instruction.

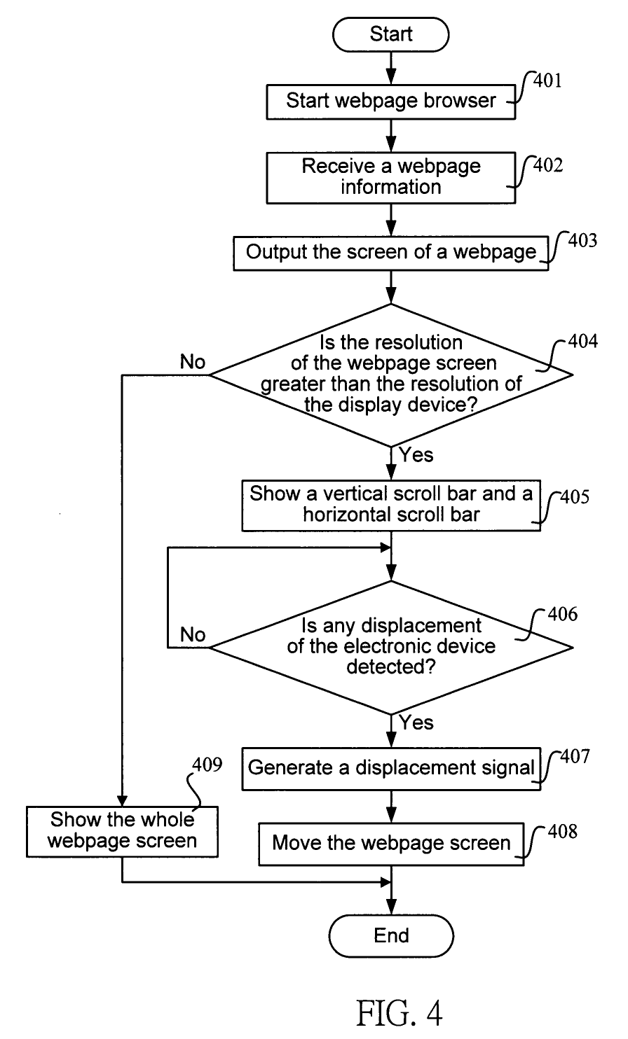

Referring to FIGS. 1 and 4 for another preferred embodiment of the present invention, the electronic device 1 further comprises a network connecting unit 5 and a storage unit 6, such that the electronic device 1 moves the display position of a screen of the display device 3 according to the steps below:

Step (401): The processor 2 starts a webpage browser 60 of the storage unit 6.

Step (402): The network connecting unit 5 receives a webpage information from a network 8.

Step (403): The webpage browser 60 outputs a webpage screen 30 outputted by the display device 3 according to the webpage information.

Step (404): Determine whether or not the resolution of the webpage screen 30 is greater than the resolution of the display device 3; if yes, then go to Step (405), or else go to Step (409).

Step (405): The webpage browser 60 shows a vertical scroll bar 32 and/or a horizontal scroll bar 34 on the webpage screen 30.

Step (406): Determine whether or not the displacement sensor 4 detects a displacement of the electronic device 1; if yes, then go to Step (407), or else go to Step (406).

Step (407): The displacement sensor 4 generates a displacement signal.

Step (408): The processor 2 issues the move instruction according to the displacement signal, and moves the vertical scroll bar 32 and/or the horizontal scroll bar 34 by the move instruction for moving the display position of the webpage screen 30.

Step (409): The webpage browser 60 shows the webpage screen 30 on the display device 3 completely.

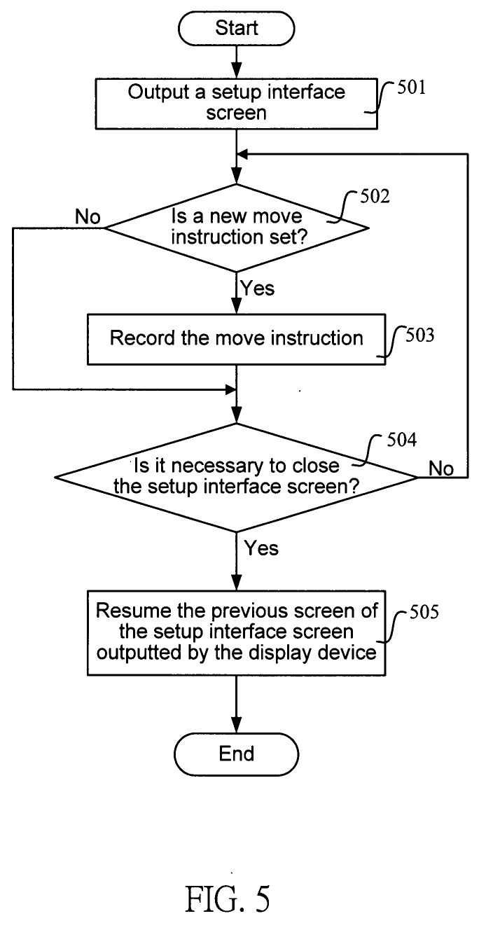

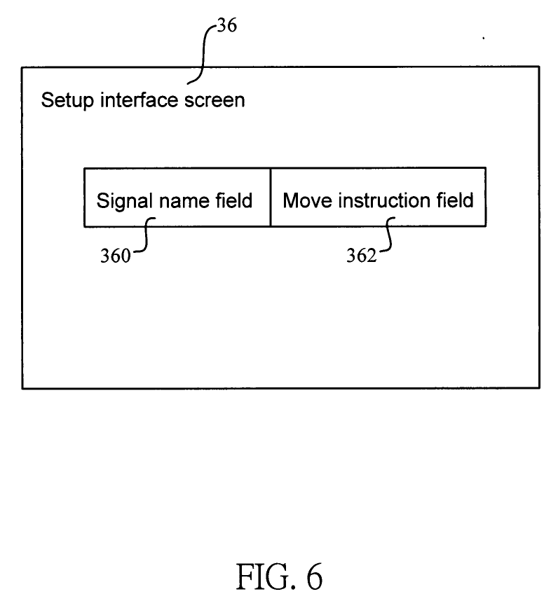

Referring to FIGS. 1, 5 and 6 for a further preferred embodiment of the present invention, the storage unit 6 further includes a setup interface 62, such that the electronic device 1 sets and records the move instruction corresponding to the displacement signal according to the steps below:

Step (501) A setup interface screen 36 is outputted on the display device 3 according to the setup interface 62, wherein the setup interface screen 36 includes at least one signal name field 360 for matching the displacement signal, and at least one move instruction field 362 for separately matching the signal name field 360, and the move instruction field 362 is provided for setting a move instruction.

Step (502): Determine whether or not the move instruction field 362 has a newly set move instruction; if yes, then go to Step (503), or else go to Step (504).

Step (503): Record a new move instruction.

Step (504): Determine whether or not to close the setup interface screen 36; if yes, then go to Step (505), or else go to Step (502).

Step (505): Close the setup interface screen 36, and resume the previous screen of the setup interface screen 36 outputted by the display device 3.

In the foregoing steps, the displacement signal includes the speed, acceleration, and direction of a displacement of the electronic device 1, and the signal name could be “Speed”, “Acceleration” and “Direction”, and the move instruction could be a speed instruction or a direction instruction for moving the horizontal scroll bar 34 and the vertical scroll bar 32.

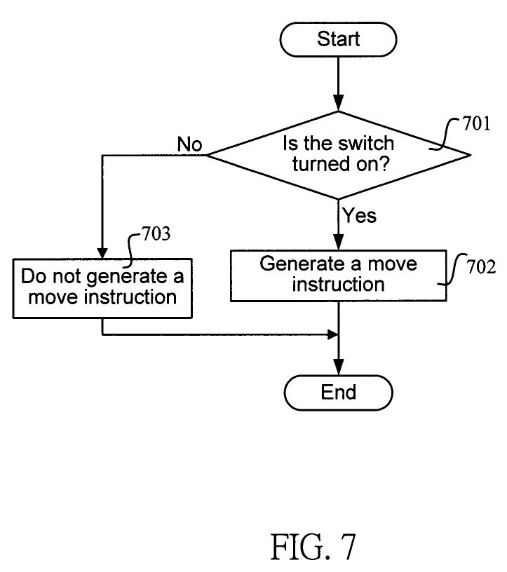

To prevent the processor 2 from issuing the move instruction continuously to move the display position of the screen unceasingly, another further preferred embodiment of the present invention as shown in FIGS. 1, 6 and 7 is provided, wherein the electronic device 1 further comprises a switch 7 disposed on a surface of the electronic device 1, so that the electronic device 1 determines whether or not to issue the move instruction according to the steps below:

Step (701): Determine whether or not the switch 7 is turned on; if yes, then go to Step (702), or else go to Step (703).

Step (702): The processor 2 issues a move instruction according to the displacement signal.

Step (703): The processor 2 does not issue a move instruction.

In summation of the description above, after the electronic device 1 is moved, the processor 2 issues a move instruction according to a displacement signal generated by the displacement sensor 4, and changes the display position of a screen of the display device 3 according to the move instruction, so as to provide a simpler and more convenient way for users to adjust the desired browsing position of a webpage on the display device 3 by existing architecture and high-resolution web pages.

While the invention herein disclosed has been described by means of specific embodiments, numerous modifications and variations could be made thereto by those skilled in the art without departing from the scope and spirit of the invention set forth in the claims.

What is claimed is:

1. An electronic device for moving the display position of a screen by a displacement sensor, comprising:
a display device, capable of outputting a screen;
a displacement sensor, capable of detecting a displacement of said electronic device to generate a displacement signal; and
a processor, connected separately to said display device and said displacement sensor, capable of issuing a move instruction according to said displacement signal for moving the display position of said screen.

2. The electronic device of claim 1, further comprises:
a network connecting unit, coupled to said processor, capable of sending a message of said electronic device to a network, and receiving a webpage information transmitted from said network; and
a storage unit, coupled to said processor and having a webpage browser for outputting a webpage screen according to said webpage information, such that when the resolution of said webpage screen is greater than the resolution of said display device, said webpage browser will show a vertical scroll bar and/or a horizontal scroll bar on said webpage screen, and said processor will move said vertical scroll bar and/or said horizontal scroll bar according to said move instruction.

3. The electronic device of claim 2, wherein said storage unit comprises a setup interface, capable of setting and recording said move instruction corresponding to said displacement signal.

4. The electronic device of claim 3, wherein said electronic device includes a switch disposed on a surface of said electronic device, capable of turning on or off the functionality of issuing the move instruction of said processor.

5. A method for moving the display position of a screen by a displacement sensor, which is applied to an electronic device having a display device and
a displacement sensor, comprising the steps of: detecting a displacement of said electronic device and generating a displacement signal by said displacement sensor;
issuing a move instruction according to said displacement signal; and
moving the display position of a screen outputted by said display device according to said move instruction.

6. The method of claim 5, wherein said electronic device further comprises a network connecting unit and a storage unit, comprising the steps of:
starting a webpage browser installed in said storage unit;
receiving a webpage information from a network by said network connecting unit;
outputting a webpage screen on said display device by said webpage browser according to said webpage information;
determining whether or not the resolution of said webpage screen is greater than the resolution of said display device; and
displaying a vertical scroll bar and/or a horizontal scroll bar on said webpage screen by said webpage browser when the resolution of said webpage screen is greater than the resolution of said display device.

7. The method of claim 6, wherein when the resolution of said webpage screen is not greater than the resolution of said display device, said webpage browser shows said webpage screen completely on said display device.

8. The method of claim 7, wherein said display position of said webpage screen is moved by moving said vertical scroll bar and/or said horizontal scroll bar.

9. The method of claim 8, wherein said storage unit further comprises a setup interface, comprising the step of:
setting and recording a move instruction corresponding to said displacement signal by the setup interface.

10. The method of claim 9, wherein said electronic device includes a switch disposed on a surface of said electronic device, comprising the step of:
issuing said move instruction according to said displacement signal when said switch is turned on.

11. The method of claim 9, wherein said electronic device includes a switch disposed on a surface of said electronic device, comprising the step of:
issuing no said move instruction when said switch is turned off.
